(19) United States
(12) Patent Application Publication
(10) Pub. No.: US 2007/0178918 A1
(43) Pub. Date: Aug. 2, 2007

(54) International messaging system and method for operating the system

(76) Inventor: Jin Hyun Shon, Seongnam-si (KR)

Correspondence Address: LADAS & PARRY LLP, 224 SOUTH MICHIGAN AVENUE, SUITE 1600, CHICAGO, IL, 60604, US

(21) Appl. No.: 11/346,024

(22) Filed: Feb. 2, 2006

(51) Int. Cl. H04Q 7/20

(52) U.S. Cl. 455/466

(57) ABSTRACT

An international messaging system for transmitting a short message between communication terminals located in respectively different countries and a method for operating the system, and more particularly, an international messaging system which can transmit a short message between communication terminals supporting different character systems of respectively different countries, and a method for operating the system. According to the present invention, it is possible to make and transmit a short message in a language of a first country from a communication terminal supporting the language of the first country to a communication terminal not supporting the language of the first country. Also, it is possible to transmit a short message in a language of a first country from a communication terminal not supporting the language of the first country to a communication terminal supporting the language of the first country.

### BACKGROUND OF THE INVENTION

1. Field of the Invention

The present invention relates to an international messaging system for transmitting a short message between communication terminals located in respectively different countries and a method for operating the system, and more particularly, to an international messaging system which can transmit a short message between communication terminals supporting different character systems of respectively different countries, and a method for operating the system.

2. Description of Related Art

Today, a mobile communication terminal provides various additional functions as well as a basic voice communication function. As a representative example, an SMS (Short Message Service.) A current short message service (SMS) receives a short message from a user via a calling communication terminal and encodes the short message in binary or hexadecimal numbers to transmit the same to a communication provider system. The communication provider system transmits the encoded short message to a receiving communication terminal, and the receiving communication terminal decodes the encoded short message and displays the decoded short message on a display means. Thus, the calling communication terminal making a short message should support a predetermined character system corresponding to the short message. Also, the receiving communication terminal receiving the short message should support a predetermined character system corresponding to the short message.

Generally, a communication terminal currently used in the U.S.A. cannot send or receive a short message containing a Korean character to a communication terminal currently used in Korea. Sending and receiving in this manner is practically impossible since the communication terminal used in the U.S.A. does not support a Korean character system.

For example, in the case a short message including a Korean character is transmitted from Korea to the U.S.A., a communication terminal used in Korea makes a short message containing a Korean character since the communication terminal supports a Korean character system, and transmits the short message to a communication provider system located in Korea. Then, the communication provider system encodes the short message and transmits the encoded short message to a communication provider system located in the U.S.A., and the communication provider system in the U.S.A. transmits the encoded short message to a communication terminal used in the U.S.A. However, since the communication terminal used in the U.S.A. generally does not support a Korean character system, the communication terminal cannot decode the encoded character message to display.

Also, as another example, in the case a short message containing a Korean character is transmitted from the U.S.A. to Korea, it is impossible to make a short message per se since a communication terminal used in the U.S.A. generally does not support a Korean character system.

In order to solve the problem such as above, there is a conventional art in which a user downloads a language pack from a communication provider system whereby a communication terminal supports a predetermined language. However, the aforementioned conventional art may increase loads to a memory of a communication terminal and also, may cause a serious problem such as a system error. Also, the time/financial burden that occurs while a user downloads and installs a language pack causes a lot of inconvenience to the user. For example, in the case a user transmits three short messages to three different countries, respectively, the user has to download each language pack for said each country, before finally being able to send the short messages. If a memory of a communication terminal has insufficient space to store all of the three language packs, the user has to repeat a cumbersome process of installing one language pack and sending a short message corresponding thereto, and removing the language pack and installing another language pack, etc.

Accordingly, a new method and system for transmitting a short message expressed in a particular language between communication terminals used in respectively different countries are required.

### BRIEF SUMMARY

An objective of the present invention is to make and transmit a short message in a language of a first country from a communication terminal supporting the language of the first country to a communication terminal not supporting the language of the first country.

Another objective of the present invention is to transmit a short message in a language of a first country from a communication terminal not supporting the language of the first country to a communication terminal supporting the language of the first country.

Another objective of the present invention is to transmit a short message in a language of a first country from a communication terminal not supporting the language of the first country to a communication terminal not supporting the language of the first country.

Another objective of the present invention is to enable a short message formed of image data to be read even in a communication terminal not supporting a corresponding language by determining whether a receiving communication terminal supports WAP (Wireless Application Protocol) or MMS (Multimedia Messaging Service) and transmitting image data to the receiving communication terminal in accordance with the determination result.

Another objective of the present invention is to pique the interest of a receiver by inserting or adding a predetermined emoticon when the short message is converted into image data.

Another objective of the present invention is to transmit a short message containing complicated contents such as equations or special characters.

In order to achieve the above objectives and solve the aforementioned problems in the conventional art, according to the present invention, there is provided an international messaging system transmitting a short message between terminals of a first country and a second country, wherein the system comprises a first system and a second system distributed in the first country and the second country, and the first system positioned in the first country comprises: a first short message receiving unit for receiving a short message inputted by a caller from a first communication provider system located in the first country; a first coding unit for encoding the received short message; and a first communication unit for transmitting the encoded short message to the second system via a predetermined communication network, the second system positioned in the second country comprises: a second communication unit for receiving the encoded short message transmitted from the first system; a second coding unit for decoding the received short message; an image converter for converting the decoded short message into image data, and recording the converted image data in a predetermined storage unit; and a receipt notification unit for controlling a receipt notification message including receipt information of the short message and address information of the storage unit to be sent to a receiver of the short message via a second communication provider system located in the second country, and the receiver receives the receipt notification message and accesses the storage unit by using the address information so as to read the image data by means of an affirmative response to the receipt notification message.

Also, according to the present invention, there is provided an international messaging method transmitting a short message between terminals of a first country and a second country, wherein an operational method of a first system positioned in the first country comprises the steps of: receiving a short message inputted by a caller from a first communication provider system; encoding the inputted short message; and transmitting the encoded short message to the second system via a predetermined communication network, and an operational method of a second system positioned in the second country comprises the steps of: receiving the encoded short message transmitted from the first system; decoding the received short message; converting the decoded short message into image data, and recording the converted image data in a predetermined storage unit; and managing a receipt notification message including receipt of the short message and address information containing the converted image data to be sent to a receiver of the short message via the second communication provider system, and the receiver receives the receipt notification message and accesses the address information containing the image data by means of an affirmative response to the receipt notification message to read the image data.

Also, according to the present invention, there is provided an international messaging method transmitting a short message between terminals of a first country and a second country, wherein an operational method of a first system comprises the steps of: maintaining image characters corresponding to a language of the first country in a database, and maintaining a character input table matching a keypad input signal of a communication terminal and the image character; receiving the keypad input signals inputted from the communication terminal on the basis of the character input table; extracting the image characters corresponding to the keypad input signals in accordance with the character input table; generating text data corresponding to the image characters; and encoding the text data to transmit the same to a second system, and the second system transmits a message including the text data transmitted from the first system to a receiver terminal via the communication provider system located in the second country.

### BRIEF DESCRIPTION OF THE DRAWINGS

The above and/or other aspects and advantages of the present invention will become apparent and more readily appreciated from the following detailed description, taken in conjunction with the accompanying drawings of which:

FIG. 1 is a view illustrating each component necessary for an international messaging system and for transmitting a short message, according to the present invention;

FIG. 2 is a view illustrating internal configuration of a first system according to FIG. 1;

FIG. 3 is a view illustrating internal configuration of a second system according to FIG. 1;

FIG. 4 is a flowchart illustrating a method for transmitting a short message in a language of a first country from a communication terminal supporting the language of the first country to a communication terminal located in a second country via an international messaging system according to the present invention;

FIG. 5 is a flowchart illustrating a method for transmitting a short message in a language of a first country from a communication terminal not supporting the language of the first country to a communication terminal located in a second country via an international messaging system according to the present invention;

FIG. 6 is a view illustrating an example of a character input table maintained in a database of FIG. 5; and

FIG. 7 is a view illustrating an example of transmitting a reply message from a receiving communication terminal to a calling communication terminal according to the present invention; and

FIG. 8 is an internal block diagram of a general-purpose computer which may be employed in implementing an international messaging method according to the present invention.

### DETAILED DESCRIPTION OF THE INVENTION

Reference will now be made in detail to embodiments of the present invention, examples of which are illustrated in the accompanying drawings, wherein like reference numerals refer to the like elements throughout. The embodiments are described below in order to explain the present invention by referring to the figures.

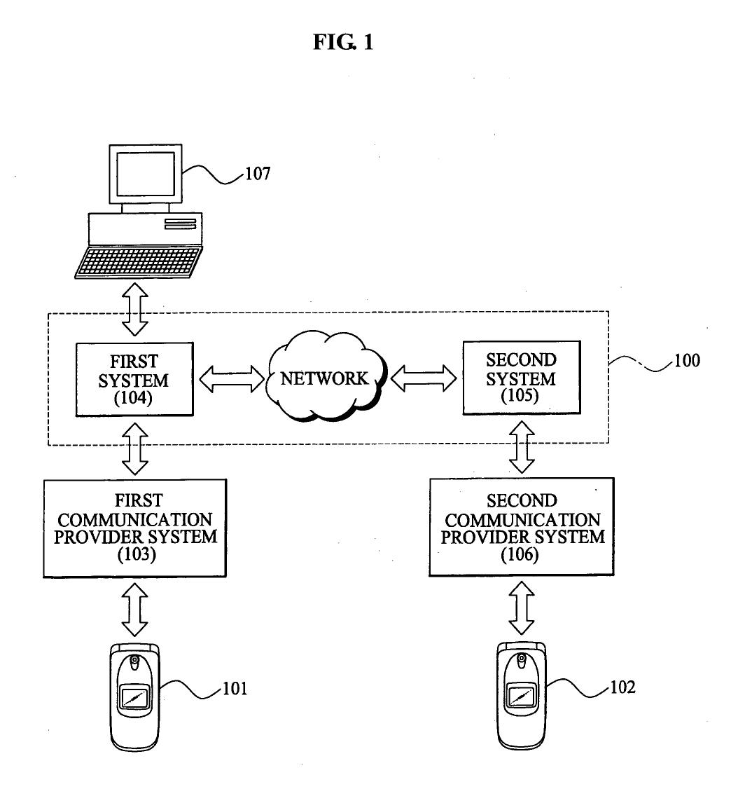

FIG. 1 is a view illustrating each component necessary for an international messaging system and for transmitting a short message, according to the present invention.

As illustrated in FIG. 1, a calling communication terminal 101 transmits a short message in a language of a first country to a first communication provider system 103 to transmit the short message to a receiving communication terminal 102. At this time, the calling communication terminal 101 and the receiving communication terminal 102 are located in respectively different countries.

The first communication provider system 103 transmits the short message to a first system 104 and requests the first system 104 to transmit the short message to the receiving communication terminal 102.

The first system 104 encodes the short message, and the short message is transmitted to a second system 105 via a network. The second system 105 decodes the encoded short message, converts the decoded short message into a short message formed of text data and processes the converted short message, thereby generating image data. The generated image data is recorded in a predetermined storage unit, and the second system 105 transmits receipt information of the image data to the receiving communication terminal 102 via a second communication provider system 106 as a receipt notification message. At this time, the receipt notification message may include a callback URL (Uniform Resource Locator), and the callback URL may be address information of the storage unit recording the image data. Thus, a user of the receiving communication terminal 102 having received the receipt notification message accesses the storage unit by using the address information included in the receipt notification message, so as to read the image data. Through this, the user may read the short message through the image data, even in the case the receiving communication terminal 102 is a terminal not supporting a language of a first country included in the short message. For example, the first communication provider system 103 inserts a CID (caller-ID) or a telephone number of a caller terminal in the short message, and the second communication provider system 106 inserts the CID or the telephone number in the image data, to transmit the same to the receiving communication terminal 102.

Also, a first embodiment that a user of the receiving communication terminal 102 transmits a response message to the short message to the calling communication terminal 101 or a second embodiment that the receiving communication terminal 102 transmits a new short message to the calling communication terminal 101 will be described.

Initially, in the first embodiment, the user of the receiving communication terminal 102 transmits a request signal for making a short message to the second system 105 and receives a predetermined character input table from the second system 105.

The character input table is a table illustrating keypad input signals of the receiving communication terminal 102 and image characters corresponding to the keypad input signals. The user of the receiving communication terminal 102 transmits a keypad input signal corresponding to a short message that the user wants to make to the second system 105 via the receiving communication terminal 102. When the transmission of the keypad input signals is completed, the user checks the keypad input signals inputted by himself or herself and transmits a short message generation request command to the second system 105. The second system 105 combines text data corresponding to the keypad input signals inputted by the user to generate a short message in the form of text data, and transmits the short message to the first system 104. At this time, the second system 105 may transmit the keypad input signals to the first system 104 directly. In the case the second system 105 sends only the keypad input signals to the first system 104, the first system 104 maintains a table recording text data corresponding to the keypad input signals and regenerates the text data.

The first system 104 having received the short message formed of text data from the second system 105 transmits the short message to the calling communication terminal 101 via the first communication provider system 103. At this time, in the case a character included in the short message received from the second system 105 is a language not supported by the calling communication terminal 101, the first system 104 converts the short message formed of text data into an image message formed of image data and provides the image message to the calling communication terminal 101. In the case the character is in a language supported by the calling communication terminal 101, the first system 104 transmits the short message to the calling communication terminal 101 by using a common method of transmitting a short message.

Accordingly, it is possible to transmit a short message from a communication terminal supporting a language of a first country to a communication terminal not supporting the language of the first country, or to transmit a short message from a communication terminal not supporting the language of the first country to a communication terminal supporting the language of the first country. Also, transmission of a short message from a communication terminal supporting the language of the first country (e.g., English) to a communication terminal supporting the language of the first country (e.g., English) is technology that is well-known before disclosing the present invention. Thus, simple modification of the aforementioned first embodiment enables transmission of a short message from a communication terminal not supporting the language of the first country to a communication terminal not supporting the same. The second embodiment may also be performed in a similar fashion to the aforementioned first embodiment.

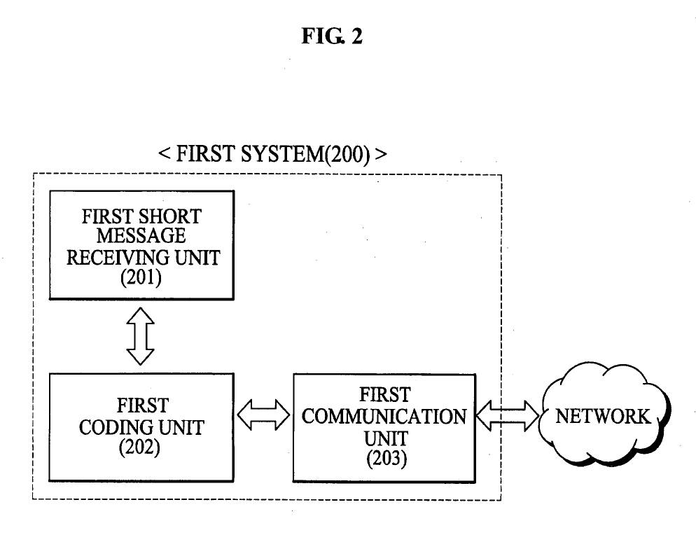

FIG. 2 is a view illustrating internal configuration of a first system according to FIG. 1.

As illustrated in FIG. 2, a first system 200 according to the present invention includes a first short message receiving unit 201, a first coding unit 202, and a first communication unit 203.

Initially, the first short message receiving unit 201 receives a short message inputted by a caller from a first communication provider system located in a first country.

The caller of the short message inputs a short message via a first communication terminal to transmit the short message to the first short message receiving unit 201. At this time, the first communication terminal is any one of a mobile communication terminal, a PDA (Personal Digital Assistant), or a computer terminal. The mobile communication terminal and the PDA transmit the short message to the first short message receiving unit 201 via a mobile communication provider system (not illustrated) as the first communication provider system, and the computer terminal transmits the short message to the first short message receiving unit 201 via a predetermined ISP (Internet Service Provider) (not illustrated) as the first communication provider system. For example, the computer terminal may transmit the short message to the first short message receiving unit 201 by using a web-based short message service, a so-called Web-to-Phone method.

The first coding unit 202 encodes the received short message. The short message is encoded by a predetermined method to be transmitted to a second system located in a second country. The encoding may apply various coding methods according to conventional transmission of data, and detailed description related thereto will be omitted here.

The first communication unit 203 transmits the encoded short message to the second system via a predetermined communication network. The communication network may employ a communication channel between countries including a predetermined network, such as an IP network, a PSTN (Public Switched Telephone Network), a satellite communication network, and the like, and a communication method via the communication channel. Detailed description related thereto will be omitted.

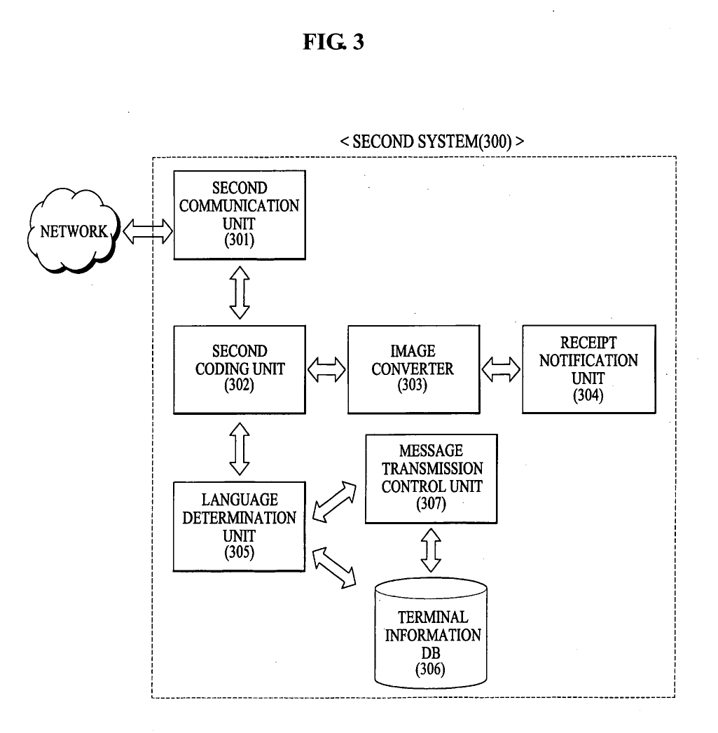

FIG. 3 is a view illustrating internal configuration of a second system according to FIG. 1.

As illustrated in FIG. 3, a second system 300 according to the present invention includes a second communication unit 301, a second coding unit 302, an image converter 303, a receipt notification unit 304, a language determination unit 305, a terminal information database 306, and a message transmission control unit 307.

Initially, the second communication unit 301 receives the encoded short message transmitted from the first system, and the second coding unit 302 decodes the received short message.

The image converter 303 converts the decoded short message into image data, and records the converted image data in a predetermined storage unit (not illustrated). Conventional art according to a text-to-image converter may be used in a method of converting the short message into image data.

The second system 300 according to an embodiment of the present invention maintains an emoticon corresponding to a particular word in a predetermined recording device, and the image converter 303 converts the particular word into the emoticon in the case the particular word is included in the decoded short message. For example, in the case the word ‘love’ is included in the short message, the storage unit maintains an emoticon of a heart shape corresponding to the word ‘love’ in a language of a first country, and the emoticon is inserted in place of the word ‘love’ of the short message, and the short message with the corresponding emoticon may be transmitted to a caller. At this time, the word ‘love’ is deleted and replaced by the emoticon, or the emoticon may be used with text data, the word ‘love’.

The second system 300 according to an embodiment of the present invention further includes the language determination unit 305.

The language determination unit 305 determines whether the decoded short message is decoded in the language of the first country or in the language of the second country, before converting the short message into image data. In the case the short message is decoded in the language of the second country, the language determination unit 305 manages the short message to be sent to the receiver via a Short Message Service Center (SMSC) of the second communication provider system. That is, in the case the decoded short message is decoded in a language of a second country supported at a receiving communication terminal, the second system 300 controls the short message to be transmitted to the receiving communication terminal via the SMSC of the second communication provider system, without converting the short message into image data via the image converter 303.

A first system according to an embodiment of the present invention includes unique identification information of a language included in the short message, and the language determination unit 305 checks the unique identification information and checks in which language the short message is written. For example, in the case a short message is written in Korean, the first system adds ‘82’ to a header of the short message as an example of unique identification information of the Korean language, and subsequently transmitting the short message to the second system 300. The second coding unit 302 decodes the short message, and the language determination unit 305 may know that the short message is written in Korean by the ‘82’ when checking the unique identification information.

The second system 300 according to an embodiment of the present invention further includes the receipt notification unit 304. The receipt notification unit 304 sends a receipt notification message including receipt information of the short message and address information containing the converted image data to a receiver of the short message.

A receipt notification message includes message contents saying that a short message has arrived at a receiving communication terminal, and is sent in a language supported at the receiving communication terminal. For example, a receipt notification message written in English is transmitted to a receiving communication terminal supporting English. The receipt notification message may be, for example, “SMS has arrived. If you want to read the message, press SEND.” Also, the receipt notification message further includes address information containing the image data, and the address information includes address information of a predetermined server and a URL of a webpage. The address information is included in the short message in form of a callback URL.

Also, the receipt notification unit 304 may process the short message into voice data via a predetermined text-to-speech unit and transmit a receipt notification message including receipt information of the short message and access information of an Automatic Response System (ARS) recording the voice data to a communication terminal of the receiver. In this case, it is unnecessary to consider which language a receiving communication terminal supports, and service may be provided irrespective of whether the receiving communication terminal is a terminal supporting mobile Internet access.

The terminal information database 306 maintains terminal number information of a communication terminal of at least one receiver and terminal specification information thereof.

The second system 300 maintains terminal number information of a receiving communication terminal that will finally receive a short message from the first system and terminal specification information thereof. For example, if a receiving communication terminal supports only a black-and-white display means, the first system may convert the image data properly in accordance with the specifications of the display means in providing the image data to the receiving communication terminal.

The terminal specification information may include information on whether the receiving communication terminal supports Wireless Application Protocol (WAP), whether the receiving communication terminal supports Multimedia Messaging Service (MMS), and whether the receiving communication terminal supports the language of the first country. The terminal specification information may be obtained from subscriber information of a communication provider system located in a second country, or may be obtained in such a manner that a user who wants to use international messaging service according to the present invention accesses a predetermined web site supporting the international messaging service according to the present invention and directly inputs his/her communication terminal number and specification information, or may be obtained by a method of acquiring subscriber terminal specification information from a predetermined service provider located in a second country.

Image data according to an embodiment of the present invention is recorded in a WAP server in the case a receiving communication terminal supports the WAP, and the receipt notification unit 304 of the second system 300 takes address information of the WAP server as a callback URL, thereby transmitting a receipt notification message to the receiving communication terminal. At this time, a user of the receiving communication terminal may read the image data by checking the receipt notification message and accessing the address information in accordance with confirmation inputted from the user of the receiving communication terminal. Also, image data according to another embodiment of the present invention is transmitted to a receiving communication terminal via a predetermined data communication channel, in the case the receiving communication terminal supports the MMS only. At this time, the user of the receiving communication terminal may read the image data by a download method or a streaming method.

Also, the terminal information database 306 maintains information on at least one language supported at the receiving communication terminal. In the case a receiving communication terminal is a communication terminal not supporting a language included in the short message, the short message cannot be read at the receiving communication terminal by an ordinary method. Accordingly, the terminal information database 306 may be used as reference data when it is determined whether the receiving communication terminal supports the language included in the short message, so as to transmit the short message.

The message transmission control unit 307 checks terminal number information of the receiving communication terminal included in the short message, and searches the terminal information database 306 on the basis of the terminal number information. The terminal number information includes a number that is identifiable from other communication terminals, such as, an Electronic Serial Number (ESN), a serial number, and a telephone number of the receiving communication terminal.

The message transmission control unit 307 first checks whether the terminal number information is registered in the terminal information database 306. As a result of the check, if registered, the message transmission control unit 307 determines whether the receiving communication terminal supports WAP or MMS and whether the receiving communication terminal supports the language of the first country, on the basis of the terminal specification information.

In a first embodiment, as a result of the check, in the case the receiving communication terminal supports only WAP without supporting the language of the first country, the message transmission control unit 307 requests the image converter 303 to covert the short message formed of text data into image data. Also, the message transmission control unit 307 transmits the converted image data to a predetermined WAP server, and controls a receipt notification message taking address information of the WAP server as a callback URL to be transmitted to the receiving communication terminal via a second communication provider system.

In a second embodiment, as a result of the check, in the case the receiving communication terminal supports only MMS without supporting the language of the first country, the message transmission control unit 307 requests the image converter 303 to convert the short message formed of text data into image data, and controls the converted image data to be transmitted to the receiving communication terminal by a download method or a streaming method. The message transmission control unit 307 requests a second communication provider system to establish a data communication channel with the receiving communication terminal and transmits the image data via the data communication channel.

In a third embodiment, as a result of the check, in the case the receiving communication terminal supports the language of the first country or the short message is written in a language of a second country, the short message is transmitted to the receiving communication terminal via a predetermined SMSC, irrespective of whether the receiving communication terminal supports WAP and MMS. It is generally the same as a method of transmitting a short message. However, in the case of the present embodiment, some system modification with respect to a communication provider system located in the second country may be required. Also, in the case of the present embodiment, an existing transmission method and system for transmitting a short message may be used as they are.

In a fourth embodiment, as a result of the check, in the case the terminal number information is not registered in the terminal information database 306, terminal specification information about a receiving communication terminal cannot be checked. In the case of the fourth embodiment, the message transmission control unit 307 may transmit a PUSH message to the receiving communication terminal in a language supported thereat. For example, when a predetermined short message has arrived, the PUSH message encouraging a user to register terminal number information and terminal specification information to the second system 300 may be transmitted to check that the message arrived or to inform the receiver a message arrived. The PUSH message includes address information through which the user can access a predetermined registration server according to the registration as a callback URL. As shown in the first embodiment to the fourth embodiment, a short message may be transmitted from a first country to a second country by using the first system and the second system 300 according to the present invention.

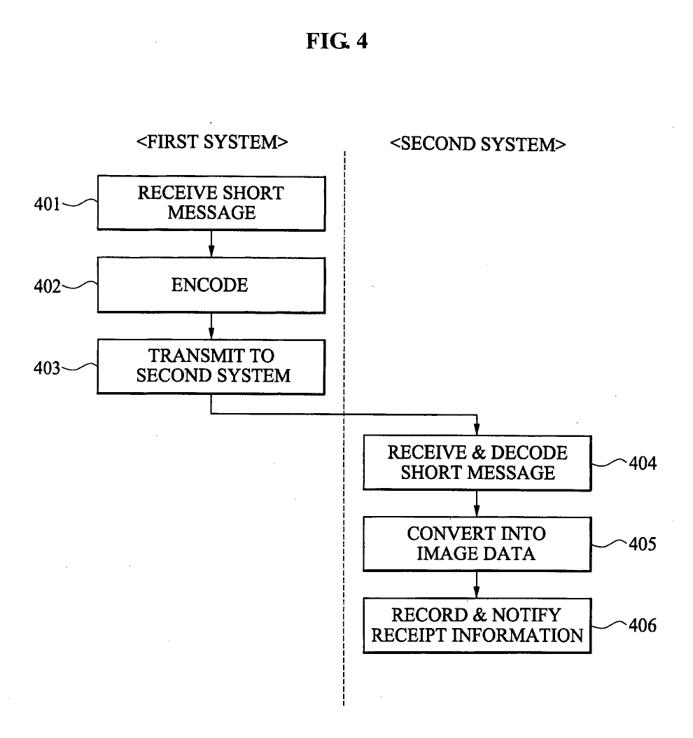

FIG. 4 is a flowchart illustrating a method of transmitting a short message in a language of a first country from a communication terminal supporting the language of the first country to a communication terminal located in a second country via an international messaging system according to the present invention.

In step 401, a caller inputs a short message in his/her own communication terminal, the inputted message is transmitted to a first communication provider system, and the first communication provider system transmits the short message to a first system according to the present invention. The short message may include predetermined identification information indicating an international short message using international messaging service. For example, the first communication provider system may check that the short message is an international short message using international messaging service through TI information included in the short message. Accordingly, the first communication provider system classifies a general domestic short message and the international short message and transmits the international short message to the first system. The first system receives the short message with the telephone number of the calling/receiving communication terminal.

In step 402, the first system encodes the received short message. In step 403, the first system transmits the encoded short message to a second system located in a second country. The short message is transmitted via a predetermined communication channel between a first country where the first system is located and the second country. The communication channel may employ any conventional communication channel for communication between countries.

In step 404, the second system receives the encoded short message transmitted from the first system and decodes the encoded short message. The second system checks terminal number information of a receiving communication terminal included in the short message after decoding the same. The second system checks whether the terminal number information is registered in the second system. Also, in the case the terminal number information is registered in the second system, the second system checks whether the receiving communication terminal supports WAP or MMS on the basis of the terminal number information.

Also, the second system checks whether the receiving communication terminal supports a language of a first country included in the short message. In the case the receiving communication terminal supports the language of the first country, the second system transmits the short message formed of text data to the receiving communication terminal via the SMSC in accordance with a general short message transmission method.

In step 405, the second system converts the short message into image data, in the case the second system does not support the language of the first country. The image data may be generated by a well-known text-to-image method. Also, a particular word included in the short message may be changed into a predetermined emoticon. For this, the second system maintains a particular word in the language of the first country and an emoticon corresponding thereto in a predetermined recording device.

In step 406, the second system records the converted image data into a predetermined storage unit.

As a result of checking whether the receiving communication terminal supports WAP or MMS on the basis of the terminal number information, in the case of supporting WAP, the image data is recorded in the WAP server. Also, the second system transmits address information of the WAP server and a predetermined receipt notification message to the receiving communication terminal via the second communication provider system. Accordingly, the receiving communication terminal may check the receipt notification message, thereby reading the image data recorded in the WAP server.

As a result of the check, in the case of supporting MMS, the second system requests the second communication provider system to establish a predetermined data communication channel with the receiving communication terminal, and transmits the image data to the receiving communication terminal via the data communication channel. For example, in the case the receiving communication terminal supports both WAP and MMS, the transmission method may be determined on the basis of a pre-determined priority order. The priority order may be determined by not only a developer of the first system and other involved parties, but also a user of the receiving communication terminal.

Also, the second system transmits record information of the image data to the receiving communication terminal as a predetermined receipt notification signal. At this time, the receipt notification signal includes address information of a storage unit recording the image data or telephone number information of the receiving communication terminal. The receiver receives the receipt notification message and accesses the storage unit by using the address information so as to read the image data by means of an affirmative response to the receipt notification message.

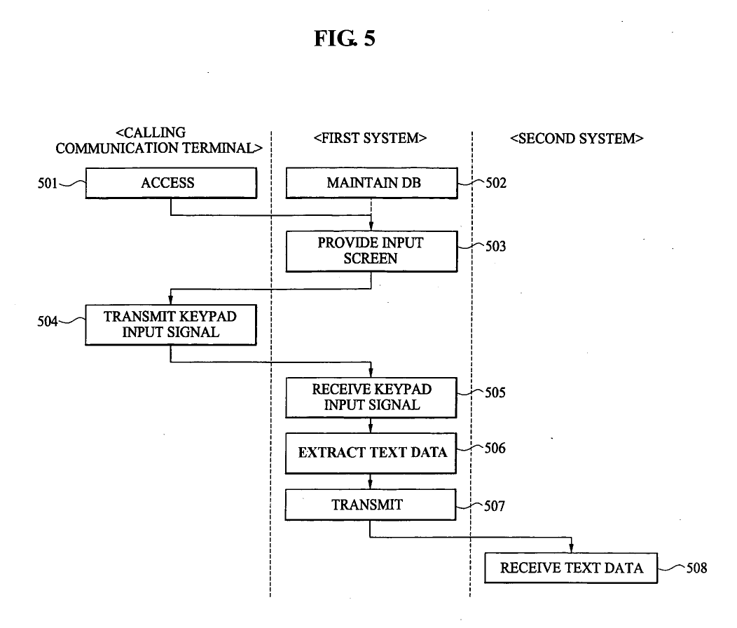

FIG. 5 is a flowchart illustrating a method for transmitting a short message in a language of a first country from a communication terminal not supporting the language of the first country to a communication terminal located in a second country via an international messaging system according to the present invention.

An international messaging method of FIG. 5 may transmit a short message in a language of a first country to a second communication terminal via a first communication terminal not supporting the language of the first country. For example, a short message in the Korean language may be transmitted from a calling communication terminal not supporting the Korean language to a receiving communication terminal.

In step 501, the calling communication terminal accesses a first system according to the present invention. At this time, in the case the calling communication terminal transmits a response message to the received short message, the calling communication terminal may access an address at which the response message may be made via a callback URL with respect to the short message. Also, in the case the calling communication terminal makes a new short message, not the response message, the calling communication terminal may access the first system via a predetermined WAP server.

In step 502, the first system maintains image characters corresponding to a language of a first country in a database, and maintains a character input table matching keypad input signals of a first communication terminal and the image characters.

In step 503, the first system provides a predetermined input screen based on the character input table to the calling communication terminal by referring to the database. In step 504, a user of the first communication terminal pushes a keypad by referring to the input screen to generate a keypad input signal and transmit the generated keypad input signal to the first system. In step 505, the first system receives the keypad input signal. In step 506, the first system extracts text data corresponding to the keypad input signal by referring to the character input table.

The user completes inputting a short message by referring to the character input table, and in step 507, the first system combines the extracted text data so as to generate a short message formed of text data, and transmits the generated short message to a second system.

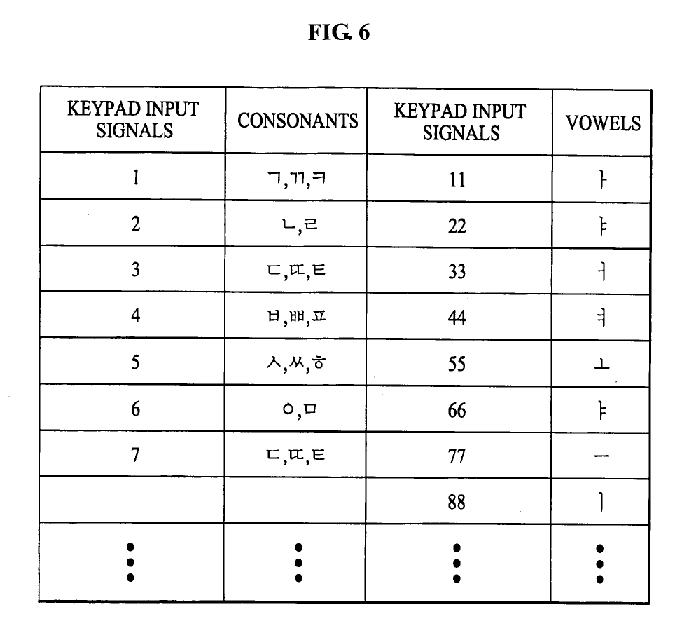

FIG. 6 is a view illustrating an example of a character input table maintained in a database described in the description of FIG. 5.

As illustrated in FIG. 6, the character input table records keypad input signals corresponding to consonants/vowels of the Korean language.

For example, in the case a user who has accessed the first system via the WAP server wants to input ‘ [symbol] [symbol] ’ as a short message, the user inputs ‘5’ as a keypad input signal of a field including ‘ [symbol] ’. At this time, since ‘ [symbol] ’ is provided in the third position among three consonants corresponding to the keypad input signal ‘5’, the user inputs ‘5’ three times. Namely, the user inputs the number ‘5’ three times on a keypad of his/her own communication terminal in order to input ‘ [symbol] ’. Next, in order to input ‘ [symbol] ’, the user inputs keypad input signal ‘11’ corresponding to the vowel ‘ [symbol] ’ via the keypad of his/her own communication terminal. In the same manner, the user inputs keypad input signal ‘2’ corresponding to ‘ [symbol] ’, and inputs ‘1’, ‘55’, and ‘1’ in turn, so as to input ‘ [symbol] ’.

Accordingly, the user inputs ‘555 11 2 1 55 1’ in the keypad of his/her own communication terminal. Also, the user may further input a special character, such as ‘*’ or ‘#’ to classify the boundary of keypad input signals corresponding to each of consonants or vowels. Also, various technologies to make a short message via a mobile communication terminal or a computer terminal are well-known with respect to configuration of selecting image characters corresponding to keypad input signals, and these technologies may be applied as they are. Also, the character input table of FIG. 6 has been described by taking the Korean language as an example, but it will be apparent to those of ordinary skills in the related art that various kinds of languages may be applied.

The first system extracts text data corresponding to the keypad input signals from a predetermined database.

The user may know the keypad input signals and image characters corresponding thereto from the keypad input table, and the first system maintains text data with respect to the image characters. Accordingly, the user performs a predetermined keypad input on the basis of the character input table, and the first system receives a keypad input signal. The keypad input signal is generated according to the keypad input.

A first system according to an embodiment of the present invention may receive a DTMF (Dual Tone Multiple Frequency) signal as a keypad input signal.

A first system according to an embodiment of the present invention receives a soft-key signal as the keypad input signal. Accordingly, the user may select an image character by using a keypad (e.g., a virtual keypad) including “direction button” and “OK button” without inputting predetermined number button or character button, so as to select the image character provided on a character input table.

The first system combines text data extracted from a database on the basis of the character input table, thereby generating a short message. Through this, combination of consonants and vowels of the Korean language extracted from the keypad input signals is re-combined into a short message formed of text data.

A first system according to an embodiment of the present invention transmits keypad input signals received on the basis of the character input table to a second system.

The first system according to an embodiment of the present invention directly transmits the keypad input signals to the second system. In this case, the second system also maintains the character input table maintaining text data corresponding to the keypad input signals. Accordingly, the second system receiving the keypad input signals may generate a short message through combination of text data in accordance with the character input table.

In step 508 of FIG. 5, the second system receives text data corresponding to the keypad input signals.

In the case a receiving communication terminal supports a language of a first country included in the short message, the short message formed of text data is transmitted to the receiving communication terminal via the SMSC. Unless the receiving communication terminal supports the language of the first country, the short message may be transmitted to the receiving communication terminal through the same method as steps 404 to 406 in FIG. 4.

Accordingly, according to the international messaging method of FIGS. 4 and 5, in a first case that a calling communication terminal supports a language of a first country and a receiving communication terminal does not support the same, in a second case that the calling communication terminal supports the language of the first country and the receiving communication terminal supports the same, in a third case that the calling communication terminal does not support the language of the first country and the receiving communication terminal supports the same, and in a forth case that the calling communication terminal does not support the language of the first country and the receiving communication terminal does not support the same, in the case the receiving communication terminal supports WAP (Wireless Application Protocol) or MMS (Multimedia Messaging Service), and in the case the receiving communication terminal does not support WAP or MMS, it is possible to transmit a short message. Namely, international short message service may be provided including all the sections that are not provided by the conventional international short message service.

A second system according to an embodiment of the present invention provides a reply message in the form of pre-recorded image data to a receiving communication terminal. The receiving communication terminal may select the reply message and request the selected reply message to be transmitted to a calling communication terminal.

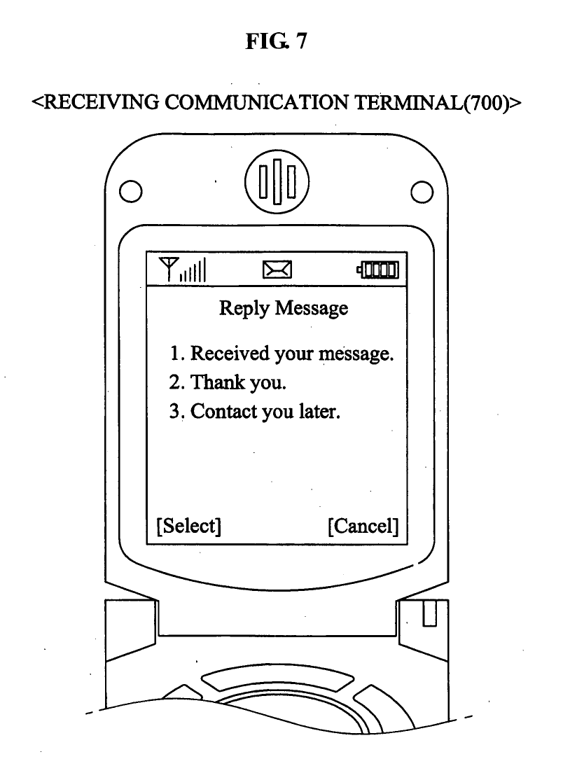

FIG. 7 is a view illustrating an example of transmitting a reply message from a receiving communication terminal to a calling communication terminal according to the present invention.

Referring to FIG. 7, a receiving communication terminal 700 reads a predetermined short message transmitted from a calling communication terminal of a first country and in a language of the first country. Also, the receiving communication terminal 700 receives at least one reply message from a second system in order to make a reply message for the short message. As an example, the reply message is in the form of image data and also includes phrases, such as ‘1. Received your message.’, ‘2. Thank you.’, and ‘3. Contact you later.” Accordingly, a receiver selects at least one reply message among the reply messages and sends the same to the calling communication terminal. In this instance, the receiver pushes a number keypad corresponding to the reply message or selects a reply message by using a navigation keypad.

A receiving communication terminal according to another embodiment of the present invention downloads an application based on BREW/Java supporting the language of the first country, from the second system. Also, the receiving communication terminal may make the reply message via the application and transmit the reply message to the calling communication terminal.

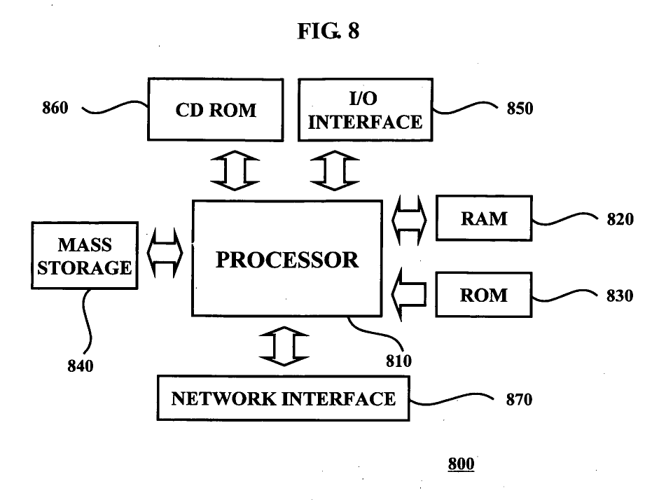

FIG. 8 is an internal block diagram of a general-purpose computer which may be employed in implementing the international messaging method according to the present invention.

The embodiments of the present invention include computer readable media including program instructions to implement various operations embodied by a computer. The media may also include, alone or in combination with the program instructions, data files, data structures, tables, and the like. The media and program instructions may be those specially designed and constructed for the purposes of the present invention, or they may be of the kind well known and available to those having skill in the computer software arts. Examples of computer-readable media include magnetic media such as hard disks, floppy disks, and magnetic tape; optical media such as CD-ROM disks; magneto-optical media such as floptical disks; and hardware devices that are specially configured to store and perform program instructions, such as read-only memory devices (ROM) and random access memory (RAM). The media may also be a transmission medium such as optical or metallic lines, wave guides, etc. including a carrier wave transmitting signals specifying the program instructions, data structures, etc. Examples of program instructions include both machine code, such as produced by a compiler, and files containing higher level code that may be executed by the computer using an interpreter.

The computer system 800 includes any number of processors 810 (also referred to as central processing units, or CPUs) that are coupled to storage devices including primary storage (typically a random access memory, or “RAM 820 ”), primary storage (typically a read only memory, or “ROM 830”). As is well known in the art, ROM 830 acts to transfer data and instructions uni-directionally to the CPU, and RAM 820 is used typically to transfer data and instructions in a bi-directional manner. Both of these primary storage devices may include any suitable type of the computer-readable media described above. A mass storage device 840 is also coupled bi-directionally to the CPU and provides additional data storage capacity and may include any of the computer-readable media described above. The mass storage device 840 may be used to store programs, data, and the like and is typically a secondary storage medium such as a hard disk that is slower than primary storage. A specific mass storage device such as a CD-ROM 860 may also pass data to the CPU. Processor 810 is also coupled to an I/O interface 850 that includes one or more input/output devices such as video monitors, track balls, mice, keyboards, microphones, touch-sensitive displays, transducer card readers, magnetic or paper tape readers, tablets, styluses, voice or handwriting recognizers, or other well-known input devices such as, of course, other computers. Finally, processor 810 optionally may be coupled to a computer or telecommunications network using a network connection as shown here as a general network interface 870. With such a network connection, it is contemplated that the CPU might receive information from the network, or might output information to the network in the course of performing the above-described method steps. The above-described devices and materials will be familiar to those of skill in the computer hardware and software arts.

The hardware elements above may be configured to act as one or more software modules for implementing the operations of this invention.

According to the present invention, it is possible to make and transmit a short message in a language of a first country from a communication terminal supporting the language of the first country to a communication terminal not supporting the language of the first country.

According to the present invention, it is possible to transmit a short message in a language of a first country from a communication terminal not supporting the language of the first country to a communication terminal supporting the language of the first country.

According to the present invention, it is possible to transmit a short message in a language of a first country from a communication terminal not supporting the language of the first country to a communication terminal not supporting the language of the first country.

According to the present invention, it is possible to determine whether a receiving communication terminal supports WAP (Wireless Application Protocol) or MMS (Multimedia Messaging Service) and transmit image data to the receiving communication terminal in accordance with the determination result.

According to the present invention, it is possible to pique the interest of a receiver by inserting or adding a predetermined emoticon when the short message is converted into image data.

According to the present invention, it is possible to transmit a short message including complicated contents such as equation or special characters.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. An international messaging system transmitting a short message between terminals of a first country and a second country, wherein:
the system comprises a first system and a second system distributed in the first country and the second country, and
the first system positioned in the first country comprises:
a first short message receiving unit for receiving a short message inputted by a caller from a first communication provider system located in the first country;
a first coding unit for encoding the received short message; and
a first communication unit for transmitting the encoded short message to the second system via a predetermined communication network,
the second system positioned in the second country comprises:
a second communication unit for receiving the encoded short message transmitted from the first system;
a second coding unit for decoding the received short message;
an image converter for converting the decoded short message into image data, and recording the converted image data in a predetermined storage unit; and
a receipt notification unit for controlling a receipt notification message including receipt information of the short message and address information of the storage unit to be sent to a receiver of the short message via a second communication provider system located in the second country, and
the receiver receives the receipt notification message and accesses the storage unit by using the address information so as to read the image data by means of a confirmative response to the receipt notification message.

2. The system of claim 1, wherein: the second system further comprises a language determination unit determining whether the decoded short message is in a language of the first country or in a language of the second country, and controlling the short message to be sent to the receiver via a Short Message Service Center (SMSC) of the second communication provider system in the case the short message is decoded in the language of the second country.

3. The system of claim 2, wherein:
the second system further comprises a terminal information database maintaining terminal number information of a communication terminal of at least one receiver and specification information on the terminal, in which the terminal specification information includes at least one piece of information on whether the terminal supports Wireless Application Protocol (WAP), whether the terminal supports Multimedia Messaging Service (MMS), and whether the terminal supports the language of the first country; and
a message transmission control unit determining whether terminal number information has been registered in the terminal information database by referring thereto in accordance with the terminal number information of a communication terminal of the receiver included in the short message, in the case it is determined that the decoded short message is decoded in the language of the first country, and if registered, determining whether the communication terminal supports Wireless Application Protocol (WAP) or Multimedia Messaging Service (MMS), or whether the communication terminal supports the language of the first country by reading the terminal specification information,
wherein the receipt notification unit transmits the receipt notification message in the case the message transmission control unit determines that the terminal number information is registered in the terminal information database and the communication terminal supports the Wireless Application Protocol (WAP).

4. The system of claim 3, wherein the receipt notification unit controls the second communication provider system to transmit the image data to the communication terminal of the receiver in form of the Multimedia Messaging Service (MMS), in the case the message transmission control unit determines that the terminal number information is registered in the terminal information database and the communication terminal supports the Multimedia Messaging Service (MMS).

5. The system of claim 3, wherein in the case the message transmission control unit determines that the terminal number information is not registered in the terminal information database, or registered in thereto without the communication terminal supporting Wireless Application Protocol (WAP), or Multimedia Messaging Service (MMS), the receipt notification unit:
(1) manages a receipt notification message including receipt of the short message and predetermined network address information to register the communication terminal in the terminal information database to be transmitted to the communication terminal of the receiver via the second communication provider system, or
(2) processes the short message into voice data via a predetermined text-to-speech unit, and controls a receipt notification message including receipt of the short message and access information of an Automatic Response System (ARS) recording the voice data to be transmitted to the communication terminal of the receiver via the second communication provider system.

6. The system of claim 3, wherein the receipt notification unit controls the second communication provider system to transmit the decoded short message to the communication terminal of the receiver, in the case the message transmission control unit determines that the terminal number information is registered in the terminal information database and the communication terminal supports the language of the first country.

7. The system of claim 1, wherein the first system inserts a caller-ID (CID) or a telephone number of a caller terminal into the short message, and the second system inserts the caller-ID (CID) or the telephone number into the image data to transmit to the receiver.

8. The system of claim 1, wherein the first short message receiving unit receives the short message from a mobile terminal of the caller or a computer terminal thereof.

9. The system of claim 1, wherein the second system maintains an emoticon corresponding to a particular word in a predetermined recording device, and the image converter converts the particular word into the emoticon in the case the particular word is included in the decoded short message.

10. The system of claim 3, wherein in the case the communication terminal supports Wireless Application Protocol (WAP) and reads the image data via a predetermined Wireless Application Protocol (WAP) server, the WAP server transmits a reading confirmation message with respect to the reading confirmation to the communication terminal of the caller.

11. The system of claim 1, wherein the receiver inputs a selection corresponding to a predetermined reply message to the second system and the second system transmits the reply message to a communication terminal of the caller according to the inputted selection.

12. An international messaging method transmitting a short message between terminals of a first country and a second country, wherein:
an operational method of a first system positioned in the first country comprises the steps of:
receiving a short message inputted by a caller from a first communication provider system;
encoding the received short message; and
transmitting the encoded short message to the second system via a predetermined communication network, and
an operational method of a second system positioned in the second country comprises the steps of:
receiving the encoded short message transmitted from the first system;
decoding the received short message;
converting the decoded short message into image data, and recording the converted image data in a predetermined storage unit; and
controlling a receipt notification message including receipt of the short message and address information containing the converted image data to be sent to a receiver of the short message via the second communication provider system, and
the receiver receives the receipt notification message and accesses the address information containing the image data by means of an affirmative response to the receipt notification message to read the image data.

13. An international messaging method transmitting a short message between terminals of a first country and a second country, wherein:
an operational method of a first system comprises the steps of:
maintaining image characters corresponding to a language of the first country in a database, and maintaining a character input table matching a keypad input signal of a communication terminal and the image character;
receiving the keypad input signals inputted from the communication terminal on the basis of the character input table;
extracting the image characters corresponding to the keypad input signals in accordance with the character input table;
generating text data corresponding to the image characters; and
encoding the text data to transmit the same to a second system, and wherein
the second system transmits a message including the text data transmitted from the first system to a receiver terminal via the communication provider system located in the second country.

14. The method of claim 13, wherein the keypad input signals are Dual Tone Multiple Frequency (DTMF) signals.

15. A computer readable record medium recording a program for implementing the method according to any one of claim 12 in a computer.
